(19) United States
(12) Patent Application Publication
(10) Pub. No.: US 2015/0246580 A1
(43) Pub. Date: Sep. 3, 2015

(54) TIRE REINFORCEMENT MATERIAL

(71) Applicant: KORDSA GLOBAL ENDUSTRIYEL IPLIK VE KORD BEZI SANAYI VE TICARET ANONIM SIRKETI, Izmit (TR)

(72) Inventors: Dogan Sevim, Izmit (TR); Kürsat Aksoy, Izmit (TR); Sadettin Fidan, Garbsen (DE); Bekir Anil Mertol, Izmit (TR)

(73) Assignee: KORDSA GLOBAL ENDUSTRIYEL IPLIK VE KORD BEZI SANAYI VE TICARET ANONIM SIRKETI, Izmit (TR)

(21) Appl. No.: 14/425,323

(22) PCT Filed: Dec. 18, 2013
(86) PCT No.: PCT/IB2013/061099

§ 371 Date: Mar. 3, 2015

(30) Foreign Application Priority Data
Dec. 25, 2012 (TR) 2012-15231

(51) Int. Cl. B60C 9/00

(52) U.S. Cl. CPC B60C 9/005; B60C 9/0042; B60C 9/0028; B60C 9/0057; B60C 2009/0078; B60C 2009/0035; B60C 2009/0092

(57) ABSTRACT

Tire reinforcement material (1) formed of cords or yarns (2, 3, 4, 5) with different elasticity moduli and which is gained bielasticity property depending on the different thermal shrinkage (TK, AS) properties thereof. To provide a tire reinforcement material (1) which has the process and performance behaviour of the classic hybrid cord, and at the same time a reduced thickness of the fabric (gauge reduction). It allows the production process and performance properties of the tire reinforcement fabric to be optimized independent from each other.

### FIELD OF THE INVENTION

The present invention relates to a tire reinforcement material which is formed of cords or yarns with different modulus and which is gained bielastic behaviour depending on the different thermal shrinkage properties.

### BACKGROUND OF THE INVENTION

The hybrid cords used as cap ply reinforcement material in pneumatic tire technology are acquired by twisting yarns having different properties with each other.

The most important difference between the yarns in the hybrid cords with two or more layers(plies) is their elastic modulus. The elastic modulus refers to the necessary force to increase the length of a material having a unit cross section area (mm²) for 100%. Bielasticity is having double modulus behaviour in stress-strain curve. In other words it is to see first low and then high modulus in stress-strain curves of fabric. For example in a double layered (plied) hybrid cord, if one of the yarns forming the layers has low modulus, the other one has high modulus (such as nylon and aramide). The function of the yarn with low modulus in the hybrid cord (such as nylon) is to enable the cap ply reinforcement fabric to elongate with the low forces which is required in tire production process and prevent tense cord formation and to cut the belt rubber which is placed under the cap ply layer (feature of the process). The function of the yarn with high modulus (such as aramide) in the hybrid cord is to prevent the tire growth caused by the centrifugal force created by the belt layers with steel cord at high speed or to keep at an acceptable level (feature of the performance).

The circular cross-sectional area of the classic hybrid cords which fulfill the process and performance requirements, is equal to the total of the cross-sectional areas of the related yarns. Therefore the diameter (thickness) of the hybrid cord increases in proportion with the total dtex values of the yarns with high and low modulus. Dtex is a yarn thickness measurement. It is the gram weight of the 10,000 meters of length of the yarn. The low and high modulus yarns of the classic hybrid cord are side by side with each other in the new product, not cabled together.

An important problem with the classic hybrid cords is the difficulty in changing the process and performance related properties independent from each other. That is, changes in dtex, twist and numbers of low and high modulus yarns exhibit themselves not only in pre-elongation or high modulus area, but also in the characteristic of the transition area from low modulus to high modulus. In other words, the said properties are interdependent in the classic hybrid cords.

However, the performance features of the tire such as comfort, maneuver ability and durability are affected from the shape and range of the transition zone of the hybrid cord from low modulus to high modulus in some degree.

South Korean Patent document no KR20050030447, an application known in the state of the art, discloses hybrid cords having high performance used in the tire as cap ply. The objective of the said invention is to provide a tire structure the adhesion of which to the rubber is enhanced, the strength of which is increased, the driving comfort of which is developed and the processabilty of which is enhanced by forming a dipped hybrid cord comprised of polyethylene naphthalate (PEN) and lyocell multi-filaments.

### SUMMARY OF THE INVENTION

The objective of the present invention is to provide a tire reinforcement material which has the process and performance related properties of the classic hybrid cord fabric, and also having the reduced fabric thickness (gauge reduction).

Another objective of the present invention is to provide a tire reinforcement material which enables the process and performance related properties of the tire reinforcement fabric to be optimized independent from each other.

### BRIEF DESCRIPTION OF THE DRAWINGS

“A tire reinforcement material” developed to fulfill the objective of the present invention is illustrated in the accompanying figures wherein,

FIG. 1 is view of the reinforcement fabric having hybrid cords obtained by twisting yarns with different properties.

FIG. 2 is the view of the reinforcement fabric having cords twisted with yarns having different properties next to each other.

FIG. 3 is the graphic showing the tensile behavior before heat treatment (A), after heat treatment (B), after heat treatment (C) (with more thermal shrinkage) in the hybrid fabric structure.

FIG. 4(a) is the view of the hybrid reinforcement fabric before heat treatment.
(b) is the view of the inventive tire reinforcement material after heat treatment.

FIG. 5(a) is the view of the hybrid reinforcement fabric having adjacent cord pairs before heat treatment.
(b) is the view of the inventive tire reinforcement material having adjacent cord pairs after heat treatment.

FIG. 6 is the view of the formation of bielastic property during heat treatment.

FIG. 7 is the view of the hybrid reinforcement fabric with parallel yarns next to each other (side by side).

FIG. 8 is the view of the hybrid reinforcement fabric having adjacent yarn pairs.

The components shown in the figures are each given reference numerals as follows:
7. Tire reinforcement material
8. Cord with low modulus
9. Cord with high modulus
10. Yarn with low modulus
11. Yarn with high modulus
12. Spacing

Ck. Warp cord

Ak. Well cord

AS. Axial compression

TK. Thermal shrinkage

KS. Compressive stress (applied by the warp cords)

### DETAILED DESCRIPTION OF THE INVENTION

The inventive tire reinforcement material (1) comprises cords or yarns with different modulus and thermal shrinkage properties as consecutive and parallel warps (Ck), and becomes a fabric having bielastic behaviour after heat treatment.

In the preferred embodiment of the invention, cords or yarns with low modulus (2, 4) used in the tire reinforcement material (1) can be nylon 6.6 or PET; and the cords or yarns with high modulus (3, 5) can be aramide, rayon, PEN carbon fiber or glass fiber.

In the preferred embodiment of the invention, the dtex values of cords or yarns (2, 3, 4, 5) in the tire reinforcement material (1) are between 100 and 3000, preferably 100 to 1000. The twist levels of the said cords and yarns (2, 3, 4, 5) are between 20 and 1000 tpm (turns per meter). The number of cords or yarns (2, 3, 4, 5) per decimeter(epdm: ends per decimeter) ranges between 50 to 200.

Cords or yarns with low modulus (2, 4) and cords or yarns (3, 5) with high modulus present in the inventive tire reinforcement material can be as cord pairs or yarn pairs. There is a certain spacing (6) between the cord or yarn pairs. The distribution of the cords or yarns (2, 3, 4, 5) can be alternating or different. The dtex values of the cords or yarns (2, 3, 4, 5) can be close to each other or different.

The inventive tire reinforcement material (1) is preferably wound on the belt package as strip and used as cap ply material.

One case, the tire reinforcement material (1) is used in the vehicle tire, the reinforcement material (1) is cut as strips and wound on the belt package of the tire such that it will make 0 to 5° angle with the equatorial plane, and it is used as cap ply reinforcement fabric. The width of the said strips varies between 5 and 25 mm, and they are used without rubber as tacky strip.

The inventive tire reinforcement material (1) used in pneumatic tires comprise alternating and parallel cords and/or yarns with low and high modulus. The thermal shrinkage (TS) of the cords and yarns with low modulus (2, 4) in the tire reinforcement material (1) is higher than that of the cords or yarns with high modulus (3, 5).

When a tensile force or load is applied on the greige fabric or strips cut from the said greige fabric, they do not show any bielastic behavior. The cords or yarns with low modulus (2, 4) in the fabric upon exposure to high temperature during dipping process (which is a heat treatment) shrink, and while shrinking they cause the cords or yarns with high modulus (3, 5) which shrink less or do not shrink at all to be compressed axially or micro-buckled. The inventive reinforcement material (1) coming out of the said heat treatment or the strips cut from this material exhibit bielastic property when a tensile force or load is applied on them.

The hybrid cords obtained by twisting yarns with different modulus (4, 5) together and their greige fabric exhibit bielastic behavior under tension, while the greige fabric comprising cords with different modulus (2, 3) next to each other does not exhibit bielastic behavior. In the inventive tire reinforcement material (1), the fabric comprised of mixed cords(hybrid fabric) are subjected to heat treatment, and the fabric is enabled to become bielastic via the cords having different thermal shrinkage (TK) values.

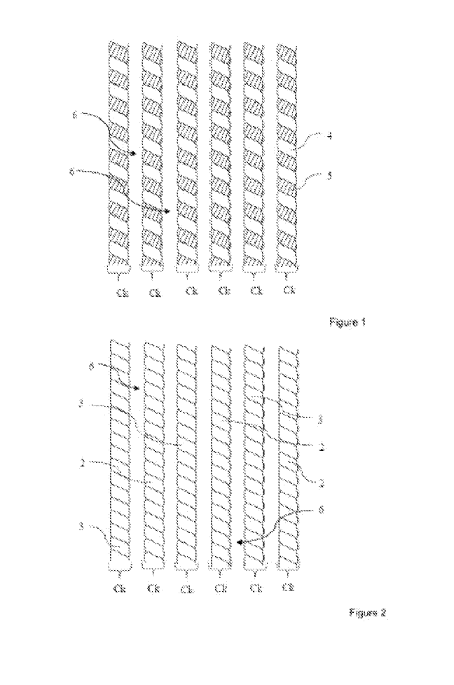

The inventive tire reinforcement material (1) is obtained by bringing the yarns and/or cords with different elastic modulus and thermal shrinkage features (2, 3, 4, 5) parallel and next to each other (FIG. 1a, 1b). The thermal shrinkage (TK) of the cords and yarns with low modulus (2, 4) in the said fabrics is higher than that of the thermal shrinkage (AS) of the cords or yarns with high modulus (3, 5).

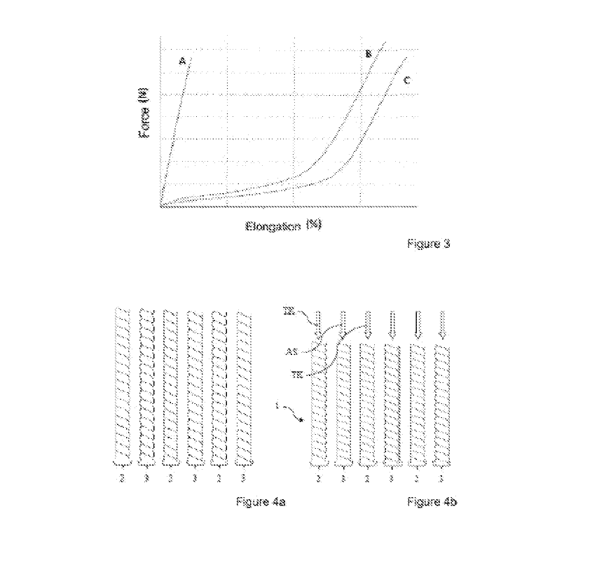

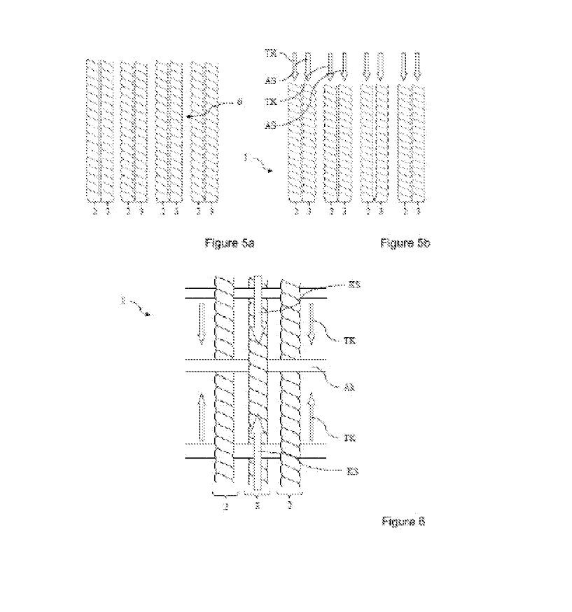

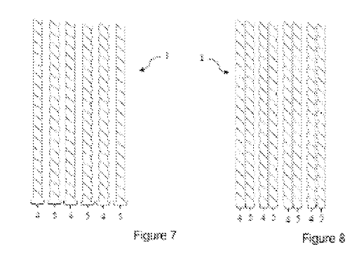

The inventive reinforcement material (1) comprised of cords with different modulus (2, 3) does not show bielastic property when it is in greige fabric form, it shows bielastic property after dipping and heat treatment. When a tensile force is applied to the inventive tire reinforcement material (1) after heat treatment, first it shows low force elongation (low modulus) and then high force elongation (high modulus). (FIG. 2)

During the inventive reinforcement material (1) gaining bielastic property, greige fabric is subjected to heat treatment, the yarns or cords with low modulus (2, 4) shrink because of high temperature and low tension, while the yarns or cords with high modulus (3, 5) next to them are forced to be compressed axially (AS) (FIG. 3, 4, 5).

The warp cords (Ck) present next to each other in the inventive tire reinforcement material (1) may have a certain spacing (6) between themselves or the double cords can be adjacent as paired. The axial compression of the cords with high modulus (3) is formed through the adhesive (RFL film) between itself and the low modulus cord (2) in adjacent position, and by the compressive stress (KS) applied by the weft cords (Ak). In cases wherein a certain distance is present between the cords with low and high modulus (2, 3), the compressive stress (KS) is applied on the cord with high modulus (3) only by the weft cords (Ak). As a result, depending on the construction of the cord or yarn with high modulus (3, 5), axial compression (AS) or micro buckling can be experienced. In case of very thin belt strips, which are obtained from the inventive tire reinforcement material (1), not warp cords (Ck), but twisted strands as warp having the dtex values of which are below 1000 are used next to each other or adjacent as pairs (FIG. 6a, 6b).

When the inventive tire reinforcement material (1) is used as cap ply reinforcement fabric in the tire, the forces caused by the increase in diameter of the tire during production process are carried by the cords with low modulus (2). The cords with high modulus (3) which are axially compressed (AS) elongate without carrying any significant force and they don't resist to the process expansion.

In order to decrease the weight and the rolling resistance in pneumatic tires, it is thought that yarns or cords with low dtex value, having low and high modulus (2, 3, 4, 5) are used next to each other and parallel to each other in tire reinforcement fabrics and they show bielastic (hybrid) behavior under tensile forces. Yarns or cords with low modulus in the inventive tire reinforcement material (1) have higher thermal shrinkage than the yarns or cords with high modulus.

The inventive tire reinforcement material (1)
5. Is much thinner than the reinforcement materials produced with classic hybrid cords with similar property.
6. Enables less rubber usage in the tire and thus causes both weight and rolling resistance to decrease.
7. Can be applied in strips as ready to use reinforcement material.
8. Provides improvement in tire performance by optimizing the transition zone from low modulus to high modulus in stress-strain behaviour.

Within the framework of these basic concepts, it is possible to develop a wide variety of embodiments of the inventive tire reinforcement material (1). The invention cannot be limited to the examples described herein and it is essentially as defined the claims.

1. A tire reinforcement material, comprising: a plurality of warps (Ck) aligned parallel to each other, wherein the warps are comprised of cords with low modulus and cords with high modulus or yarns with low modulus and yarns with high modulus, and becomes bielastic fabric as a result of different thermal shrinkage after heat treatment.

2. The tire reinforcement material according to claim 1, wherein cords or yarns with low modulus used in the tire reinforcement material are nylon 6.6 or PET; and the cords or yarns with high modulus are aramide, rayon, PEN, carbon fiber or glass fiber.

3. The tire reinforcement material according to claim 1, wherein the dtex values of cords or yarns are between 100 and 3000.

4. The tire reinforcement material according to claim 1, wherein the twist levels of cords or yarns are between 20 and 1000 tpm (turns per meter).

5. The tire reinforcement material according to claim 1, wherein the numbers (end counts) of cords or yarns are between 50 and 200 ends per decimeter (epdm).

6. The tire reinforcement material according to claim 1, wherein yarns or cords with low modulus enable the yarns or cords with high modulus next to them to be axially compressed while thermal shrinking depending on the temperature and tension during heat treatment.

7. The tire reinforcement material according to claim 1, wherein warp cords (Ck) have a spacing between them to create an area for movement.

8. The tire reinforcement material according to claim 1, wherein warp cords (Ck) are in pairs adjacent to each other.

9. The tire reinforcement material according to claim 1, wherein the tire reinforcement material is used as cap ply by being wound on tire belt in st-rips such that it will make 0 to 5° angle with the equatorial plane.

10. The tire reinforcement material according to claim 9, wherein the width of which the said strips varies between 5 and 25 mm and they are used without rubber as tacky strips.
